(19) United States
(12) Patent Application Publication
(10) Pub. No.: US 2015/0084273 A1
(43) Pub. Date: Mar. 26, 2015

(54) SHEET CONVEYING APPARATUS AND IMAGE FORMING APPARATUS

(71) Applicant: CANON KABUSHIKI KAISHA, Tokyo (JP)

(72) Inventor: Yasuhiro Shimoi, Toride-shi (JP)

(21) Appl. No.: 14/483,473

(22) Filed: Sep. 11, 2014

(30) Foreign Application Priority Data
Sep. 26, 2013 (JP) 2013-199276

(51) Int. Cl. B65H 7/06; B65H 9/14; B65H 5/36; B65H 7/20; G03G 15/00; B65H 5/06

(52) U.S. Cl. CPC B65H 7/06; G03G 15/6529; B65H 5/068; B65H 5/36; B65H 7/20; B65H 9/14
USPC 271/228; 271/226; 271/227; 271/265.01; 271/258.01

(57) ABSTRACT

A sheet conveying apparatus including: a cover that is provided in an apparatus main body in an openable and closable manner to open a sheet conveying path through which the sheet is conveyed, by rotating in an open direction from a closed position; a guide member that is movably provided in the cover and forms the sheet conveying path; and a moving portion that is provided with a contact portion coming into contact with the sheet conveyed through the sheet conveying path, and is movably provided in the guide member; wherein the guide member moves with respect to the cover by rotating the cover in the open direction from the closed position, and thereby the moving portion moves by its own weight in a direction in which the contact portion of the moving portion is retracted from the sheet conveying path.

### BACKGROUND OF THE INVENTION

1. Field of the Invention

The present invention relates to a sheet conveying apparatus that conveys a sheet, and an image forming apparatus having the same.

2. Description of the Related Art

Conventionally, in a sheet conveying apparatus used in an electrophotographic system image forming apparatus, a detector that detects a position, a posture or the like of a sheet within a sheet conveying path is provided, and the conveyance control of the sheet is performed depending on the detected information. In the detector that brings a detection element such as a lever (moving portion) into contact with the sheet, there is a configuration that protrudes onto the sheet conveying path, but it is necessary to prevent the detection element from being damaged due to contact of the sheet or the user during jam recovery or the like.

Thus, a configuration for solving the above-described problems has been conventionally suggested. U.S. Patent Application Publication No. 2011/233856 A1 discloses a configuration that brings the components into contact with each other by utilizing a difference in position of a center of rotation of each of an exterior cover, a sheet guide and a detection element that rotate when accessing the conveying path, and retracts the detection element into the sheet guide. Furthermore, Japanese Patent Laid-Open No. 2010-64851 suggests a configuration in which the exterior cover has a center of rotation with respect to the substantially horizontal conveyance path, and the detection element is vertically lowered by its own weight and is retracted within the guide, by rotating the exterior cover up to the substantially vertical direction about the center of rotation of downstream in the conveying direction.

However, an opening angle of the exterior cover are limited, there is a problem that rotation required for retraction of the detection element cannot be achieved.

### SUMMARY OF THE INVENTION

It is therefore desirable to solve the above-described problems and to prevent damage to the moving portion.

In order to achieve the above-described object, according to the invention, there is provided a sheet conveying apparatus having: a cover that is provided in an apparatus main body in an openable and closable manner to open a sheet conveying path through which a sheet is conveyed, by rotating in an open direction from a closed position; a guide member that is movably provided in the cover and forms the sheet conveying path; and a moving portion that is provided with a contact portion which comes into contact with the sheet conveyed within the sheet conveying path, and is movably provided in the guide member, wherein the guide member moves with respect to the cover by rotating the cover in the open direction from the closed position, and thereby the moving portion moves by its own weight in a direction in which the contact portion of the moving portion is retracted from the sheet conveying path.

According to the invention, it is possible to prevent damage to the moving portion in the jam recovery or the like, by retracting the contact portion of the moving portion into the guide member when opening the cover.

Further features of the present invention will become apparent from the following description of exemplary embodiments with reference to the attached drawings.

### BRIEF DESCRIPTION OF THE DRAWINGS

FIG. 1 is a cross-sectional view illustrating an overall configuration of an image forming apparatus having a sheet conveying apparatus according to this example.

FIG. 2 is a cross-sectional view illustrating a configuration of periphery of a loop detection portion in the sheet conveying apparatus of a first example.

FIGS. 3A and 3B are cross-sectional views illustrating a sheet conveying state in the sheet conveying apparatus of the first example.

FIG. 4 is a partial cross-sectional view illustrating an open state of an exterior cover of the first example.

FIGS. 5A and 5B are cross-sectional views illustrating a retract configuration of a loop sensor flag of the first example.

FIGS. 6A and 6B are cross-sectional views illustrating a closed state of the exterior cover of a second example.

FIGS. 7A and 7B are cross-sectional views illustrating the open state of the exterior cover of the second example.

### DESCRIPTION OF THE EMBODIMENTS

Hereinafter, exemplary embodiments of the invention will be illustratively described in detail referring to the drawings. However, dimensions, materials, and shapes of the components, and relative arrangements thereof described in the following embodiments are to be appropriately changed, depending on the configuration and various conditions of the apparatus to which the invention is applied. Therefore, unless otherwise specified, the scope of the invention is not intended to be limited to only the embodiments.

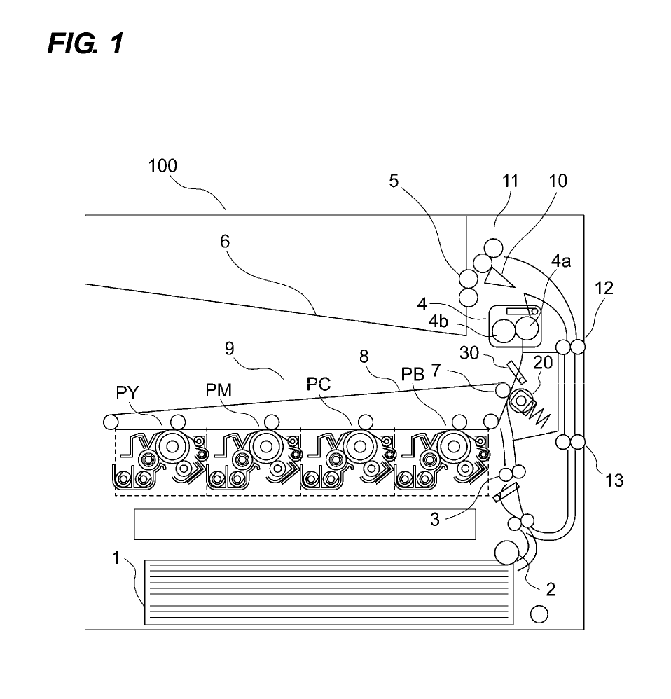

An overall configuration of an image forming apparatus having a sheet conveying apparatus will be described with reference to FIG. 1 together with the image forming operation. In addition, FIG. 1 is a cross-sectional view of a full color printer as the image forming apparatus having the sheet conveying apparatus.

First, in the image forming operation, at each of image forming portions PY, PM, PC, and PB, a toner image is formed on a photosensitive drum by an electrophotographic system. That is, a front side of the rotating photosensitive drum is uniformly charged by a primary charger, and an electrostatic latent image is formed by performing exposure of the photosensitive drum according to an image signal from a laser exposure device. A toner image is formed on the photosensitive drum by performing the toner development of the electrostatic latent image by a developing device to be converted to a visible image. By bias application of the toner image to a transfer roller, the toner image is transferred onto a rotating intermediate transfer belt 8. A full color image is formed by superimposing and transferring the transfer of the toner image onto the intermediate transfer belt 8 in the order of yellow (Y), magenta (M), cyan (C), and black (B).

After the sheet set in a sheet cassette 1 in synchronization with the image forming operation is fed by a feeding roller 2 one by one and is conveyed to a skew feeding correction portion 3 to correct the skew feeding, the sheet is further conveyed to a secondary transfer portion. At the secondary transfer portion, a secondary transfer roller 20 is disposed on an opposite side of a secondary transfer inner roller 7 of an intermediate transfer unit 9, and the toner image on the intermediate transfer belt 8 is secondary transferred onto the conveyed sheet by the bias application to the secondary transfer roller 20. Moreover, the sheet on which the toner image is transferred is conveyed to a fixing device 4 including a fixing roller and a pressure roller through a sheet conveying path formed by a guide member to be described later, and is heated and pressed while passing through a nip portion between both rollers, and the toner image is fixed thereon.

In the sheet conveying path between the secondary transfer roller 20 and the fixing device 4, a loop detection portion 30 that detects a loop amount as an amount of slackening of the sheet is provided. The loop detection portion 30 detects the time when the loop amount of the sheet reaches a predetermined amount or higher. A controller 50 performs a variable speed control of the fixing roller so that the loop amount of the sheet is maintained within a predetermined range, based on a signal from the loop detection portion 30. That is, the controller 50 controls the conveying speed of the sheet by the fixing device as a conveying portion so that the loop amount of the sheet is maintained within a predetermined range. For this reason, the conveying speed of the sheet in the fixing device 4 does not affect the conveying speed of the sheet at the nip portion between the secondary transfer roller 20 as a secondary transfer portion and the secondary transfer inner roller 7.

The sheet on which the toner image is fixed as described above is discharged to a discharge tray 6 by a discharge roller 5 in the case of one-side recording. In the case of duplex image forming, the conveying path of the sheet is switched by a switching member 10, the sheet is conveyed by a reversing roller 11, and immediately after a rear end of the sheet has passed a branch point, the sheet is switching-conveyed and guided to a duplex conveying path. Moreover, after the sheet is conveyed to the secondary transfer portion again by duplex rollers 12 and 13 or the skew feeding correction portion 3 to form the image on the back side, the sheet is finally discharged to the discharge tray 6 through the fixing device 4, thereby finishing the series of image forming operations.

### FIRST EXAMPLE

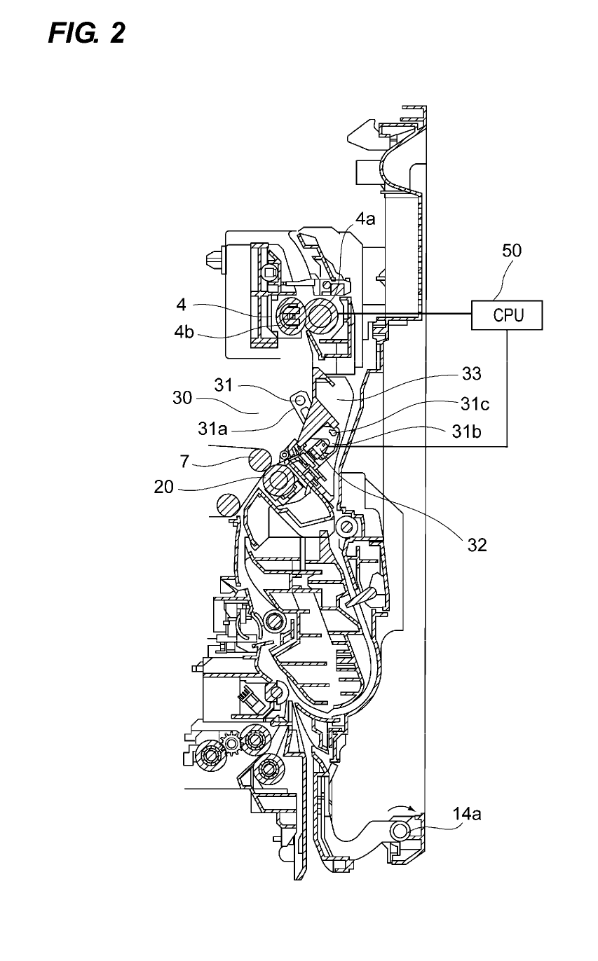

A configuration of the periphery of the loop detection portion in the sheet conveying apparatus according to the first example is illustrated in FIGS. 2 to 5B. Here, as the sheet conveying apparatus, a conveying portion from the secondary transfer portion to the fixing device in the image forming apparatus will be described as an example.

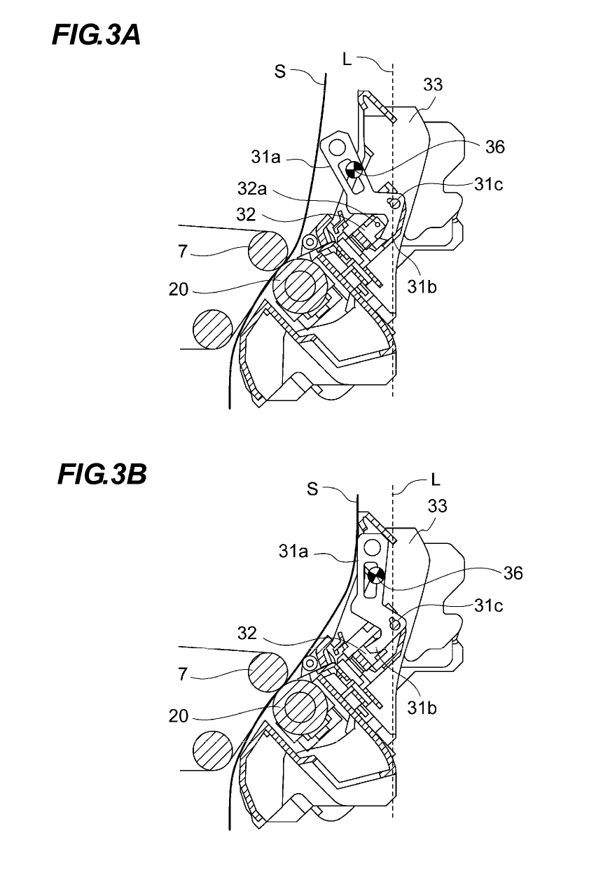

Between the secondary transfer portion and the fixing device 4, a secondary transfer guide 33 as a guide member is provided which forms a sheet conveying path through which the sheet is guided. The above-described loop detection portion 30 is provided in the secondary transfer guide 33. The loop detection portion 30 includes a loop sensor flag 31 as a detection element which is rotatably held on the secondary transfer guide 33, and a photo sensor 32 as a detector which is fixedly held on the secondary transfer guide 33. The loop sensor flag 31 forming the moving portion includes a sheet contact portion 31a that is provided to be able to come into contact with the sheet conveyed within the sheet conveying path and can come into contact with the sheet within the sheet conveying path, a detection portion 31b detected by the photo sensor 32, and a rotary shaft 31c serving as the center of rotation. The exterior cover 14 has a center of rotation 14a at the bottom of an apparatus main body 100, and is provided to be able to opened and closed with respect to the apparatus main body 100. The exterior cover 14 is held at a closed position illustrated in FIGS. 2 and 3 to form the sheet conveying path during printing operation, and rotates in an open direction from the closed position to open the sheet conveying path when performing the periodic replacement, the jam recovery of the consumable components or the like. Here, a configuration in which the sheet conveying path guides the sheet conveyed to the upper side from the lower side in vertical direction is described as an example.

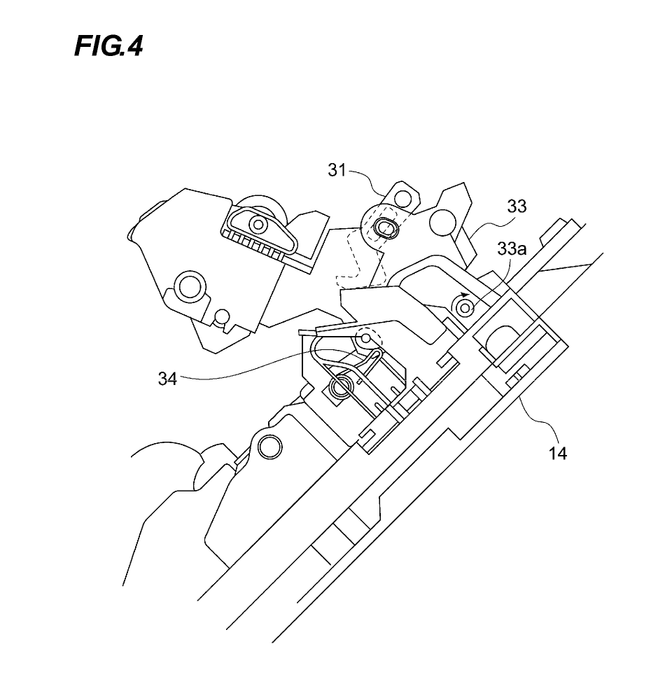

Furthermore, the secondary transfer guide 33 is held to be rotatable (swingable) with respect to the exterior cover 14 so that the bottom thereof rotates in the same direction as the exterior cover 14 toward the inside of the apparatus main body 100 about the center of rotation 33a of the top (see FIG. 4). Additionally, the secondary transfer guide 33 is biased toward the inside of the apparatus main body 100 by a guide biasing spring 34 as an elastic member fixed to the exterior cover 14. Thus, as illustrated in FIG. 4, when rotating the exterior cover 14 in the open direction, the secondary transfer guide 33 is biased by the biasing force of the guide biasing spring 34, and rotates in the same direction as the exterior cover 14. Here, the secondary transfer guide 33 rotates in a clockwise direction as the same direction as the rotation direction (clockwise direction) around a center of rotation 14a of the exterior cover 14, around the center of rotation 33a of the top.

Furthermore, as described above, the controller 50 provided in the apparatus main body 100 controls the conveying speed of the sheet by the fixing device 4 to maintain the loop amount of the sheet between the secondary transfer roller 20 and the fixing device 4 in a constant range, based on the signal from the loop detection portion 30. Furthermore, here, the controller included in the image forming apparatus is illustrated as an example, but the invention is not limited thereto. For example, a controller included in the sheet conveying apparatus attached in a detachably attachable manner to the image forming apparatus as an option may be used, or a configuration that performs the control by the controller of the sheet conveying apparatus and the controller of the image forming apparatus may be used.

### [Closed State of Exterior Cover]

When the exterior cover 14 is held at the closed position, as illustrated in FIG. 3A, a sheet contact portion 31a of the loop sensor flag 31 protrudes from the secondary transfer guide 33, a position of center of gravity 36 of the loop sensor flag 31 within the range of rotation is located on the sheet conveying path side from the vertical line L passing through the center of rotation (rotary shaft 31c). At this time, the sheet contact portion 31a is biased by a force of approximately 0.0019 N to 0.049 N (0.2 gf to 5 gf) in the collapse direction by gravity (sheet conveying path side from the vertical line L). The photo sensor 32 is provided near the detection portion 31b of the loop sensor flag 31. When the loop (slackening) of the sheet S is a predetermined value or higher at the sheet conveying path between the secondary transfer roller 20 and the fixing device 4, the sheet S abuts against the sheet contact portion 31a, and as illustrated in FIG. 3B, the loop sensor flag 31 rotates in the direction of retracting into the secondary transfer guide 33 from the sheet conveying path about the rotary shaft 31c. As a result, the detection portion 31b of the loop sensor flag 31 blocks the detector 32a of the photo sensor 32, the detection signal of the photo sensor 32 is turned ON, and the controller 50 detects that the loop (slackening) of the sheet S in the sheet conveying path becomes a constant level or higher.

### (Loop Control of Fixing Device)

The diameter of the pressure roller 4a of the fixing device 4 changes by being affected by the temperature of the heated state of the fixing roller (heating roller) 4b and the fixing state to the sheet. Therefore, when rotating at a constant speed, the sheet conveying speed is high when the temperature of the pressure roller 4a is high, and the sheet conveying speed is slow when the temperature is low.

Therefore, the variable control of the fixing roller is performed, based on the detection information of the loop detection portion from just before the leading end of the sheet enters the fixing nip as a nip portion between the pressure roller and the fixing roller until the trailing end of the sheet exits the fixing nip, and the loop amount of the sheet is maintained at a constant amount. The loop control of the sheet performed in this section will be described.

In the loop control of the sheet in the sheet conveying path between the secondary transfer roller 20 and the fixing device 4, the above-described controller 50 changes the rotational speed of the pressure roller 4a at the following three steps, based on the detection signal from the loop detection portion 30.

(1) Just before and just after the leading end of the sheet enters the fixing nip, the rotational speed of the pressure roller 4a rotates at −2% with respect to the speed of the secondary transfer portion.

(2) In the state in which sheet is nipped between both the fixing device and the secondary transfer portion, when the loop detection portion is turned ON, the rotational speed of the pressure roller 4a is switched to the rotation of −1%, the speed becomes higher than the secondary transfer portion, and the loop (slackening) of the sheet is eliminated. When the loop detection portion is turned OFF, the rotational speed of the pressure roller 4a is switched to rotation of −6%, the speed becomes lower than the secondary transfer portion, and the loop (slackening) of the sheet grows. By repeating the switching of the rotational speed, the loop amount of the sheet in the sheet conveying path between the secondary transfer roller 20 and the fixing device 4 is maintained within a constant range.

(3) When the trailing end of the sheet exits the secondary transfer portion, the pressure roller 4a rotates at a rotational speed of 2% to secure the interval between the trailing end and the succeeding sheet.

### [Open State of Exterior Cover]

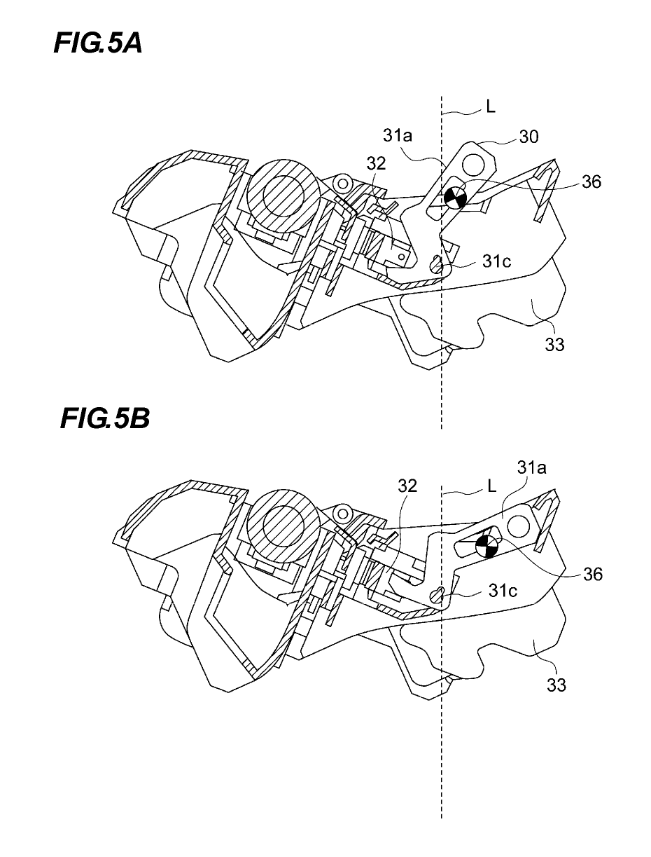

From a relation of an installation area or the like, at the open position, the exterior cover 14 is often held at an opening angle of about 30° to 50° with respect to the closed position. In this example, the exterior cover 14 is held at the position of 45° (open position) with respect to the closed position. The secondary transfer guide 33 that rotatably holds the loop detection portion 30 is held to be rotatable (swingable) with respect to the exterior cover 14. Moreover, when rotating the exterior cover 14 in the open direction, the bottom of the secondary transfer guide 33 rotates around the center of rotation 33a of the top toward the inside of the apparatus main body 100 in the same direction as the exterior cover 14. In addition, the secondary transfer guide 33 is biased toward the inside of the apparatus main body 100 by the guide biasing spring 34 as an elastic member fixed to the exterior cover 14. Therefore, as illustrated in FIG. 4, when rotating the exterior cover 14 in the open direction, the secondary transfer guide 33 is biased by the biasing force of the guide biasing spring 34, and rotates in the same direction as the exterior cover 14. Here, the secondary transfer guide 33 tilts to the exterior cover 14 by about 10° to 20°. Thus, within all the ranges of rotation, or within a partial range of rotation including the loop detection position (ON position), the center of gravity of the loop sensor flag 31 is moved to the side surface side of the apparatus main body 100 on the side opposite to the sheet conveying path from the vertical line L passing through the center of rotation (rotary shaft 31c). This movement allows the loop sensor flag 31 to move by its own weight in the direction in which the sheet contact portion 31a is retracted to the inside of the secondary transfer guide 33 (FIGS. 5A and 5B).

In the state illustrated in FIG. 5B in which the loop sensor flag 31 is retracted to the inside of the secondary transfer guide 33, even when the operator performs the work near the guide for replacement of consumable components or jam recovery, it is possible to prevent damage to the loop sensor flag due to the contact of the sheet or the operator.

### SECOND EXAMPLE

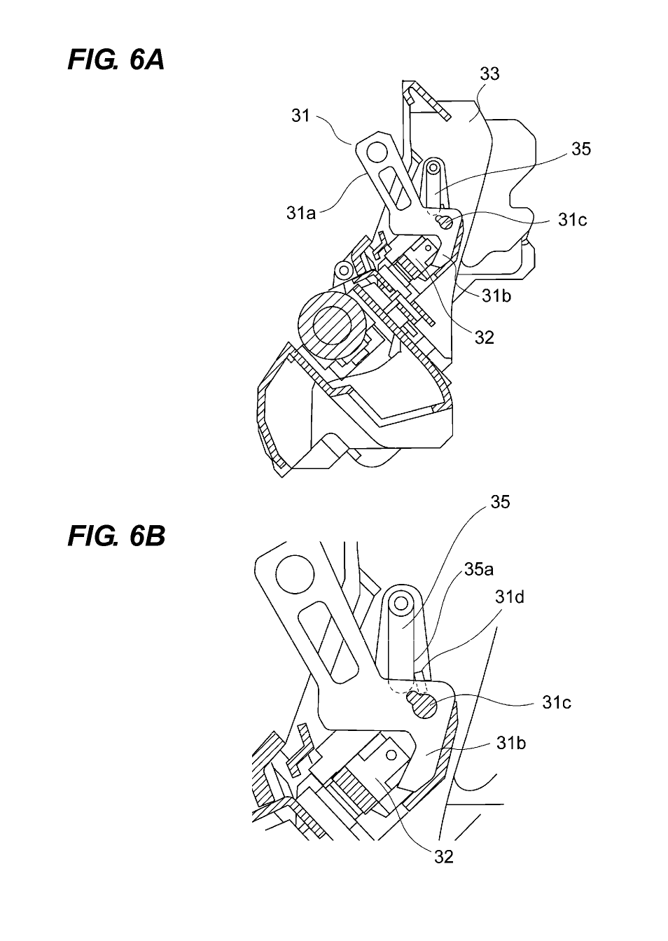

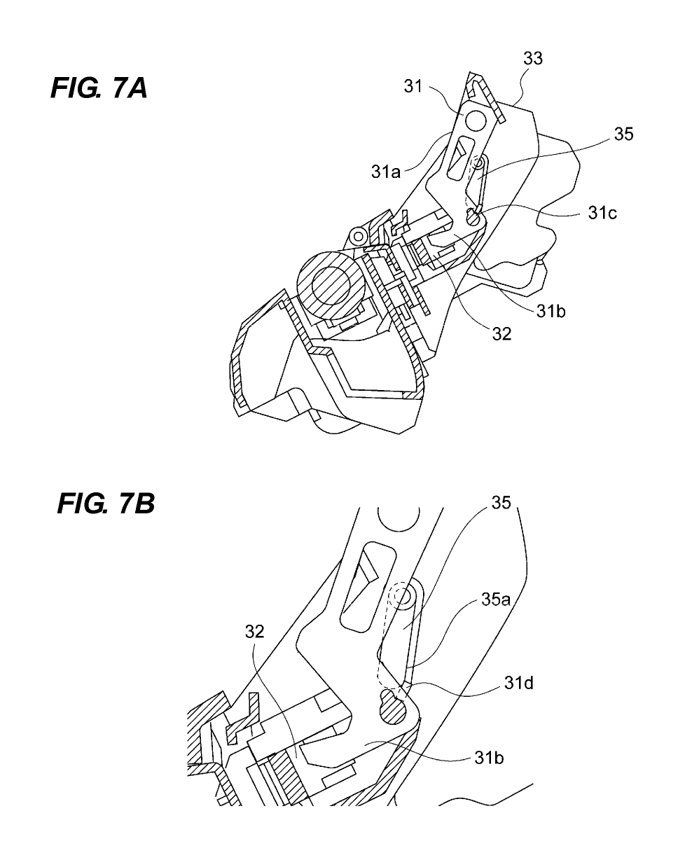

FIGS. 6A, 6B, 7A and 7B illustrate the configuration of the loop detection portion around the sheet conveying apparatus according to the second example. The same configurations of the image forming apparatus except for the configuration around the loop detection portion as those of the above-described example are denoted by the same reference numerals and the descriptions thereof will not be provided.

The loop sensor flag 31 forming the loop detection portion of this example has a retraction auxiliary portion 31d, in addition to the sheet contact portion 31a, the detection portion 31b, and the rotary shaft 31c.

In addition, in the secondary transfer guide 33 of this example, a flag retraction member 35 as an auxiliary member to assist the rotation of the loop sensor flag 31 is provided to be rotatable by its own weight. The flag retraction member 35 is provided in the vicinity of the loop sensor flag 31. When the exterior cover 14 is located at the closed position, as illustrated in FIGS. 6A and 6B, the flag retraction member 35 forming the moving portion with the loop sensor flag 31 is disposed to stop at a position that does not interfere with the rotation of the loop sensor flag 31. By rotating the exterior cover 14 in the open direction from the closed position, the flag retraction member 35 rotates by its own weight, and an abutment portion 35a abuts against the retraction auxiliary portion 31d of the loop sensor flag 31, thereby biasing the loop sensor flag 31, in the direction of retracting the sheet contact portion 31a of the loop sensor flag 31 to the inside of the secondary transfer guide 33 on the side opposite to the sheet conveying path.

### [Closed State of Exterior Cover]

When the exterior cover 14 is held at the closed position, as illustrated in FIGS. 6A and 6B, the sheet contact portion 31a of the loop sensor flag 31 projects from the secondary transfer guide 33, and the position of center of gravity 36 within the range of rotation of the loop sensor flag 31 is located on the sheet conveying path side from the vertical line passing through the center of rotation (rotary shaft 31c). At this time, the sheet contact portion 31a is biased in the collapse direction by gravity (sheet conveying path side from the vertical line), by force of about 0.0019 N to 0.049 N (0.2 gf to 5 gf). The photo sensor 32 is provided near the detection portion 31b of the loop sensor flag 31. At the sheet conveying path between the secondary transfer roller 20 and the fixing device 4, when the loop (slackening) of the sheet S is a constant value or higher, the sheet S abuts against the sheet contact portion 31a, and the loop sensor flag 31 rotates around the rotary shaft 31c in the direction of being retracted from the sheet conveying surface. As a result, the detection portion 31b of the loop sensor flag 31 blocks the detector 32a of the photo sensor 32, the detection signal of the photo sensor 32 is turned ON, and the controller 50 detects that the loop (slackening) of the sheet S in the sheet conveying path becomes a constant level or higher.

In addition, as described above, when the exterior cover 14 is held at the closed position, the flag retraction member 35 held on the secondary transfer guide 33 to be rotatable by its own weight stops at a position that does not interfere with rotation of the loop sensor flag 31.

Furthermore, since the loop control of the fixing device is the same as that described in the aforementioned examples, the description thereof will not be provided here.

### [Open State of Exterior Cover]

Similarly to the above-described examples, at the open position, the exterior cover 14 is held at an opening angle of about 45° with respect to the closed position. The secondary transfer guide 33 that rotatably holds the loop detection portion 30 is held to be rotatable (swingable) with respect to the exterior cover 14. Moreover, when rotating the exterior cover 14 in the open direction, the bottom of the secondary transfer guide 33 rotates around the center of rotation 33a of the top toward the inside of the apparatus main body 100 in the same direction as the exterior cover 14. In addition, the secondary transfer guide 33 is biased toward the inside of the apparatus main body 100 by the guide biasing spring 34 as an elastic member fixed to the exterior cover 14. Therefore, when rotating the exterior cover 14 in the open direction from the closed position, the secondary transfer guide 33 is biased by the biasing force of the guide biasing spring 34 and rotates in the same direction as the exterior cover 14.

Furthermore, at this time, in the course in which the exterior cover 14 is shifted to the open position from the closed position, the flag retraction member 35 rotates by its own weight, and the abutment portion 35a abuts against the retraction auxiliary portion 31d of the loop sensor flag 31 to bias the loop sensor flag 31 in the direction of retracting the sheet contact portion 31a of the loop sensor flag 31 into the secondary transfer guide 33. Biasing force to the loop sensor flag 31 due to rotation of the flag retraction member 35 by its own weight is large enough for the biasing force by which the loop sensor flag 31 rotates to the sheet conveying path side.

For that reason, at the open position of the exterior cover 14, the center of gravity of the loop sensor flag 31 at the retracted position is located outside the apparatus main body 100 on the side opposite to the sheet conveying path side from the vertical line passing through the center of rotation (rotary shaft 31c). Thus, the loop sensor flag 31 stops at the retracted position of the inside of the secondary transfer guide 33 in the open state of the exterior cover 14.

In the state illustrated in FIGS. 7A and 7B in which the loop sensor flag 31 is retracted to the inside of the secondary transfer guide 33, even when the operator performs the work near the guide for replacement of consumable components or jam recovery, it is possible to prevent damage to the loop sensor flag due to the contact of the sheet or the operator.

### OTHER EXAMPLES

In the above-described examples, the configuration in which the loop sensor flag 31 is retracted to the inside of the secondary transfer guide 33 has been described as an example, but the invention is not limited thereto, and the invention is effective even in other sensor flags and actuators.

In the above-described examples, the configuration in which the exterior cover 14 is held at the open position at an opening angle of about 30° to 50° with respect to the closed position, more specifically, the exterior cover 14 is held at a position (open position) of 45° with respect to the closed position has been described as an example, but the invention is not limited thereto. The opening angle from the closed position to the open position of the exterior cover 14 may be 90° or less.

In the above-described examples, as the conveying portion that controls the loop amount of the sheet to be maintained in a constant range, the fixing device 4 located at downstream in the sheet conveying direction of the loop detection portion 30, but the invention is not limited thereto. As long as any conveying portion detects the loop amount of the sheet by the loop detection portion 30 and is controlled based on the detection signal, other conveying portions may be used, and the conveying portion may be applied to other sheet conveying apparatuses, without being limited to the sheet conveying apparatus leading to the fixing device from the secondary transfer portion.

In the above-described examples, the configuration in which the image forming apparatus has four image forming portions of different colors has been described as an example, but the number of use is not limited and may be appropriately determined as needed.

In the above-described examples, the printer has been described as the image forming apparatus, but the invention is not limited thereto. For example, other image forming apparatuses, such as a copying machine and a facsimile machine, or another image forming apparatus such as a complex machine in which these functions are combined may be used. Alternatively, an image forming apparatus which uses a recording material carrier, and transfers the toner images of respective colors on the recording material supported on the recording material carrier in a sequentially superimposed manner. It is possible to obtain the same effects by applying the invention to the sheet conveying apparatus of such an image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-199276, filed Sep. 26, 2013, which is hereby incorporated by reference herein in its entirety.

What is claimed is:

1. A sheet conveying apparatus comprising:
a cover that is provided in an apparatus main body in an openable and closable manner to open a sheet conveying path through which a sheet is conveyed, by rotating in an open direction from a closed position;
a guide member that is movably provided in the cover and forms the sheet conveying path; and
a moving portion that is provided with a contact portion coming into contact with the sheet conveyed through the sheet conveying path, and is movably provided in the guide member,
wherein the guide member moves with respect to the cover by rotating the cover in the open direction from the closed position, and thereby, the moving portion moves by its own weight in a direction in which the contact portion of the moving portion is retracted from the sheet conveying path.

2. The sheet conveying apparatus according to claim 1,
wherein the guide member is rotatably held on the cover, and rotates in the same direction as the cover, when rotating the cover in the open direction.

3. The sheet conveying apparatus according to claim 2,
wherein the guide member is biased by an elastic member provided in the cover, and rotates in the same direction as the cover by biasing force of the elastic member when rotating the cover in the open direction.

4. The sheet conveying apparatus according to claim 1, further comprising a detector which outputs a signal depending on a position of the moving portion moved by the conveyed sheet,
wherein the moving portion is held on the guide member so as to rotate by being pressed against the sheet conveyed along the sheet conveying path,
wherein, when the cover is held at the closed position, a center of gravity of the moving portion is located on the sheet conveying path side with respect to a vertical line passing through a center of rotation of the moving portion, and the contact portion projects to the sheet conveying path by its own weight, and
wherein, when rotating the cover in the open direction from the closed position, the center of gravity of the moving portion moves to an opposite side to the sheet conveying path side with respect to the vertical line passing through the center of rotation of the moving portion, and the contact portion is retracted by its own weight.

5. The sheet conveying apparatus according to claim 1,
wherein the moving portion has:
a detection element that is provided with the contact portion, and is held on the guide member so as to rotate by being pressed against the sheet conveyed through the sheet conveying path, and
an auxiliary member that assists rotation of the detection element, and is rotatable to the guide member,
the sheet conveying apparatus further comprising a detector which outputs a signal depending on a position of the detection element,
wherein, when the cover is located at the closed position, the auxiliary member stops at a position that does not interfere with the rotation of the detection element, and
wherein, by rotating the cover in the open direction from the closed position, the auxiliary member rotates by its own weight to bias the detection element in a direction that retracts the contact portion of the detection element from the sheet conveying path.

6. The sheet conveying apparatus according to claim 1,
wherein an opening angle of the cover is 90° or less.

7. The sheet conveying apparatus according to claim 1,
wherein the sheet conveying path conveys the sheet to an upper side from a lower side in the vertical direction.

8. The sheet conveying apparatus according to claim 1, further comprising:
a detector which outputs a signal depending on a position of the moving portion moved by the conveyed sheet;
a conveying portion that is provided at downstream of the sheet conveying direction from the moving portion and conveys the sheet; and
a controller that controls a conveying speed of the sheet by the conveying portion to maintain an amount of slackening of the sheet in a constant range, based on the signal of the detector.

9. A sheet conveying apparatus comprising:
an apparatus main body;
a cover that is movably supported on the apparatus main body;
a guide member that is supported on the cover, the guide member moving with respect to the cover with the movement of the cover; and
a detection element that is movably supported on the guide member, and is disposed to be able to come into contact with the conveyed sheet in a state in which the cover is positioned at the closed position,
wherein, in the state in which the cover is positioned at the closed position, an own-weight of the detection element acts to rotate the detection element in a first direction, and in a state in which the cover is opened, the own-weight of the detection element acts to rotate the detection element in a second direction opposite to the first direction.

10. The sheet conveying apparatus according to claim 9,
wherein the cover is rotatably held on the apparatus main body, and
wherein the guide member is rotatably held on the cover, and rotates in the same direction as the cover when rotating the cover in the open direction.

11. The sheet conveying apparatus according to claim 9,
wherein the guide member forms a sheet conveying path along which the sheet is conveyed,
wherein, when the cover is held at the closed position, the center of gravity of the detection element is located on the sheet conveying path side with respect to the vertical line passing through the center of rotation of the detection element, and the detection element projects into the sheet conveying path by its own weight, and
wherein, when rotating the cover in the open direction from the closed position, the center of gravity of the detection element moves to an opposite side to the sheet conveying path side with respect to the vertical line passing through the center of rotation of the detection element, and the detection element is retracted to the inside of the guide member by its own weight.

12. The sheet conveying apparatus according to claim 9, further comprising:an elastic portion that is provided between the cover and the guide member and moves the guide member with respect to the cover with the movement of the cover.

13. The sheet conveying apparatus according to claim 9,
wherein an opening angle of the cover is 90° or less.

14. The sheet conveying apparatus according to claim 9,
wherein the sheet conveying path conveys the sheet to an upper side from a lower side in the vertical direction.

15. The sheet conveying apparatus according to claim 9, further comprising:
a detector which outputs a signal depending on a position of the detection element moved by the conveyed sheet;
a conveying portion that is provided at downstream of the sheet conveying direction from the detection element and conveys the sheet; and
a controller that controls a conveying speed of the sheet due to the conveying portion to maintain an amount of slackening of the sheet in a constant range, based on the signal of the detector.

16. A sheet conveying apparatus comprising:
a cover that is provided in an apparatus main body in an openable and closable manner to open a sheet conveying path through which the sheet is conveyed, by rotating in an open direction from a closed position;
a guide member that is movably provided in the cover and forms the sheet conveying path;
a detection element that is provided with a contact portion coming into contact with the sheet conveyed through the sheet conveying path, and is movably provided in the guide member; and
an auxiliary member that is movably provided in the guide member and assists the movement of the detection element,
wherein the guide member moves with respect to the cover by rotating the cover in the open direction from the closed position, and thereby, the auxiliary member moves by its own weight to move the detection element in a direction in which the contact portion of the detection element is retracted from the sheet conveying path.

17. The sheet conveying apparatus according to claim 16,
wherein the guide member is rotatably held on the cover, and rotates in the same direction as the cover when rotating the cover in the open direction.

18. The sheet conveying apparatus according to claim 17,
wherein the guide member is biased by an elastic member provided in the cover, and rotates in the same direction as the cover by biasing force of the elastic member when rotating the cover in the open direction.

19. The sheet conveying apparatus according to claim 16,
wherein, when the cover is held at the closed position, the center of gravity of the detection element is located on the sheet conveying path side with respect to the vertical line passing through the center of rotation of the detection element, and the detection element projects into the sheet conveying path side from the guide member by its own weight in all range of rotation of the detection element, and
wherein, when rotating the cover in the open direction from the closed position, the center of gravity of the detection element moves to the opposite side to the sheet conveying path side with respect to the vertical line passing through the center of rotation of the detection element, and the detection element is retracted to the inside of the guide member on the opposite side to the sheet conveying path side by its own weight.

20. The sheet conveying apparatus according to claim 16,
wherein the sheet conveying path conveys the sheet to an upper side from a lower side in the vertical direction.

21. The sheet conveying apparatus according to claim 16, further comprising:
a conveying portion that is provided at downstream in the sheet conveying direction from the detection element and conveys the sheet; and
a controller that controls a conveying speed of the sheet due to the conveying portion to maintain an amount of slackening of the sheet in a constant range based on the signal of the detector.

22. An image forming apparatus comprising:
the sheet conveying apparatus according to claim 1; and
an image forming portion that forms an image on a sheet conveyed by the sheet conveying apparatus.
